(19) United States
(12) Patent Application Publication
(10) Pub. No.: US 2024/0213727 A1
(43) Pub. Date: Jun. 27, 2024

(54) GUIDED MAGNETIC RF CONNECTOR ASSEMBLY AND ADAPTER THEREOF

(71) Applicant: Rapidtek Technologies Inc., New Taipei (TW)

(72) Inventors: Hui-Chen Wu, New Taipei (TW); Po-Chieh Huang, New Taipei (TW)

(21) Appl. No.: 18/203,674

(22) Filed: May 31, 2023

(30) Foreign Application Priority Data
Dec. 23, 2022 (TW) 111149826

(51) Int. Cl. H01R 24/50; H01R 31/06

(52) U.S. Cl. CPC H01R 24/50; H01R 31/06

(57) ABSTRACT

A guided magnetic RF connector assembly and a guided magnetic RF adapter assembly are provided. The assemblies comprise a male connector. The male connector comprises a guide groove, a plug terminal, and a plug surrounding the plug terminal. The guide groove has a funnel-like shape. An upper diameter at the open side of the guide groove is greater than a column diameter of a female connector or a RF adapter, and a lower diameter near the bottom side of the guide groove is adapted to the column diameter of the female connector or the RF adapter. The models of the male/female connectors and the RF adapters may be 1.0 mm, SMPS, 1.35 mm, 1.85 mm, SMPM, 2.4 mm, 2.92 mm, SMP, 3.5 mm, SMA, or N, but not limited thereto. The assemblies provided can be applied to various frequency bands, and the maximum operating frequency band may reach 110 GHz.

### CROSS REFERENCE TO RELATED APPLICATIONS

The present application claims the benefit of Taiwanese Patent Application No. 111149826 filed on Dec. 23, 2022, the contents of which are incorporated herein by reference in their entirety.

### BACKGROUND

### 1. Field of the Invention

This disclosure relates to a RF connector assembly and a RF adapter assembly, in particular to a guided magnetic RF connector assembly and a guided magnetic RF adapter assembly.

### 2. Description of the Related Art

Radiofrequency (RF) connectors or RF adapters thereof are currently widely used in the connection of coaxial cables, antenna sockets, and optical fibers. With the popularization of wireless signal transmission, the antenna of communication equipment needs to be designed to meet the needs of receiving signals in different frequency bands. Therefore, an RF connector is often used to connect the antenna to transmit the signal to the circuit of the communication device.

In addition to larger-sized RF connectors or RF adapters for coaxial cables, many small-sized RF connectors or RF adapters have been developed as communication equipment shrinks. In the past, RF connectors or RF adapters were connected by rotating threads. However, installation of small-sized RF connectors is time-consuming and often causes damage or breakage of the plug terminals due to installation errors.

Although a magnetic attraction type of RF connector has been developed to replace conventional RF connectors with rotating thread, it significantly saves the time required for connecting the male and female connectors. However, the magnetic RF connectors still cannot overcome the problem of damage or breakage of the plug terminals due to installation errors, and this problem is even more likely to occur than the rotary threaded RF connector. The reason is that when a magnetic RF connector is used, if there is no proper alignment, the female connector will impact the plug terminal on the male connector due to magnetic attraction force, resulting in damage or breakage of the plug terminal.

### SUMMARY

Accordingly, how to develop RF connectors and assemblies thereof that can solve the alignment problem of the conventional magnetic attraction RF connectors has become a problem to be solved for those skilled in the art.

In order to solve the above problems, an aspect of this disclosure is to provide a guided magnetic RF connector assembly, which is adapted to magnetically connect guided magnetic RF connectors. The assembly comprises a female connector and a male connector. The female connector comprises a column, a connection groove, and a socket. The connection groove is sunken at the central axis of the column, and the socket is located at the central axis of the connection groove and thus surrounded by the connection groove. The male connector comprises a guide groove, a plug terminal, and a plug surrounding the plug terminal. The guide groove has a funnel-like shape. An upper diameter at the open side of the guide groove is greater than the column diameter, and a lower diameter near the bottom side of the guide groove is adapted to the column diameter. The plug terminal is located at the central axis of the guide groove for connecting the socket, and the plug is adapted to engage with the connection groove when the plug terminal is connected to the socket.

In another aspect, this disclosure provides a method for connecting the guided magnetic RF connector assembly described above. The method comprises the following steps. First, the female connector and the male connector are magnetically attracted. Then, the column of the female connector is magnetically guided to close to the guide groove of the male connector. Next, the connection groove of the female connector and the plug of the male connector are connected to simultaneously connect the socket of the female connector and the plug terminal of the male connector.

In yet another aspect, this disclosure provides a guided magnetic RF adapter assembly. The assembly comprises a RF adapter for magnetically connecting guided magnetic RF connectors and a male connector. The RF adapter comprises an adapter column, an adapter connection groove, and an adapter socket. The adapter connection groove is sunken at the central axis of the adapter column, and the adapter socket is located at the central axis of the adapter connection groove and thus surrounded by the adapter connection groove. The male connector comprises a guide groove, a plug terminal, and a plug surrounding the plug terminal. The guide groove has a funnel-like shape. An upper diameter at the open side is greater than the adapter column diameter, and a lower diameter near a bottom side of the guide groove is adapted to the adapter column diameter. The plug terminal is located at the central axis of the guide groove for connecting the socket, and the plug is adapted to engage with the connection groove when the plug terminal is connected to the socket.

In yet another aspect, this disclosure also provides a method for connecting the guided magnetic RF adapter assembly stated above. The method comprises the following steps. First, the RF adapter and the male connector are magnetically attracted. Then, the adapter column of the RF adapter is magnetically guided to close to the guide groove of the male connector. Next, the adapter connection groove of the RF adapter and the plug of the male connector are connected to simultaneously connect the adapter socket of the RF adapter and the plug terminal of the male connector.

According to some embodiments of this disclosure, the models of the male and female connectors and the RF adapter above may be 1.0 mm, SMPS, 1.35 mm, 1.85 mm, SMPM, 2.4 mm, 2.92 mm, SMP, 3.5 mm, SMA, or N, but not limited thereto. The assemblies above can be applied to various frequency bands; the maximum operating frequency band may reach 110 GHz. Specifically, according to some embodiments of this disclosure, the assemblies above are suitably used for connecting RF connectors and/or RF adapters with guide grooves as the connection medium and through magnetic attraction.

In light of foregoing, the technical effects of this disclosure include:
(1) When the distance between the female connector (or RF adapter) and the male connector is farther, it is convenient for an operator to connect the female connector (or RF adapter) and the male connector through mutual magnetic attraction force.
(2) A guide groove is designed on the male connector so that the column of the female connector can easily approach and aligns with the male connector along the guide groove of the male connector. Therefore, the improper alignment between the female connector (or RF adapter) and the female connector (or RF adapter) resulting in damage or breakage of the plug terminals can be avoided.
(3) After alignment, the plug on the male connector can be locked into or engaged with the connection groove (or RF adapter connection groove) provided by the female connector (or RF adapter). Therefore, the plug terminal of the male connector is connected to the socket (or RF adapter socket) of the female connector (or RF adapter).

Accordingly, the guided magnetic RF connector assembly and the guided magnetic RF adapter assembly provide a technical solution for a two-stage connection of “magnetic guidance” and “connection.” While avoiding damage or breakage of the plug terminals, the connection efficiency is effectively increased.

### BRIEF DESCRIPTION OF THE DRAWINGS

In order to allow the above-mentioned and other purposes, features, advantages and embodiments of this disclosure to be more clearly understood, the accompanying drawings are described as following:

FIG. 1 is a perspective schematic view of a male connector according to an embodiment of this disclosure.

FIG. 2 is a perspective schematic view of the male connector in FIG. 1 with an A-A sectional line.

FIG. 3 is a perspective schematic view of a female connector with a B-B sectional line, according to an embodiment of this disclosure.

FIG. 4 is a sectional schematic view of the male connector viewed from the A-A sectional line in FIG. 2 and the female connector viewed from the B-B sectional line in FIG. 3, and the male and female connectors are not connected.

FIG. 5 is a sectional schematic view of the male connector viewed from the A-A sectional line in FIG. 2 and the female connector viewed from the B-B sectional line in FIG. 3, and the male and female connectors are not connected.

FIG. 6 is a sectional schematic view of the male connector viewed from the A-A sectional line in FIG. 2 and the female connector viewed from the B-B sectional line in FIG. 3, and the male and female connectors are connected.

FIG. 7 is a perspective schematic view of a RF adapter with a C-C sectional line, according to an embodiment of this disclosure.

FIG. 8 is a sectional schematic view of the male connector viewed from the A-A sectional line in FIG. 2 and the RF adapter viewed from the C-C sectional line in FIG. 7, and the male connector and the adapter are not connected.

FIG. 9 is a sectional schematic view of the male connector viewed from the A-A sectional line in FIG. 2 and the RF adapter viewed from the C-C sectional line in FIG. 7, and the male connector and the adapter are not connected.

FIG. 10 is a sectional schematic view of the male connector viewed from the A-A sectional line in FIG. 2 and the RF adapter viewed from the C-C sectional line in FIG. 7, and the male connector and the adapter are connected.

FIG. 11 is a perspective schematic view of a male connector connected to a PCB adapter, according to an embodiment of this disclosure.

FIG. 12 is a perspective schematic view of a male connector connected to a threaded adapter, according to an embodiment of this disclosure.

### DESCRIPTION OF THE PREFERRED EMBODIMENTS

In order to describe various embodiments of this disclosure in more detail, the following description is supplemented with accompanying drawings.

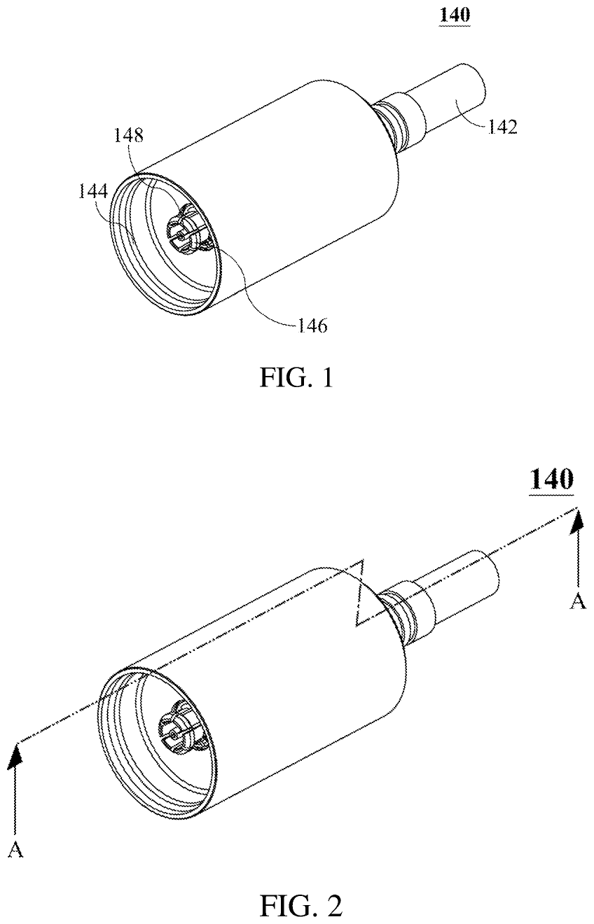

In FIGS. 1-6, a guided magnetic RF connector assembly is provided according to some embodiments of this disclosure. The model of the male and female connectors may be 1.0 mm, SMPS, 1.35 mm, 1.85 mm, SMPM, 2.4 mm, 2.92 mm, SMP, 3.5 mm, SMA, and N. These models may work under various frequency bands. The maximum operating frequency band may reach 110 GHZ.

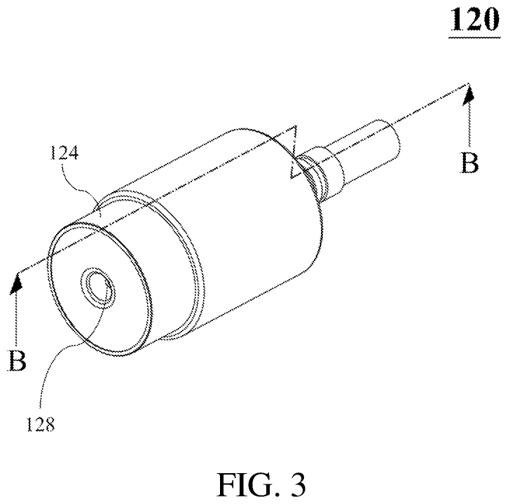

Please refer to FIGS. 1-3. FIG. 1 is a perspective schematic view of a male connector according to an embodiment of this disclosure. FIG. 2 is a perspective schematic view of the male connector in FIG. 1 with an A-A sectional line. FIG. 3 is a perspective schematic view of a female connector with a B-B sectional line, according to an embodiment of this disclosure.

In FIG. 1, one end of the male connector 140 is connected to a second wire 142, and the other end of the male connector has a protective sleeve forming a guide groove 144 to surround a plug 146 and a plug terminal 148. In FIG. 3, one end of the female connector 120 is connected to a first wire 122, and the other end has a column 124 and a socket 128.

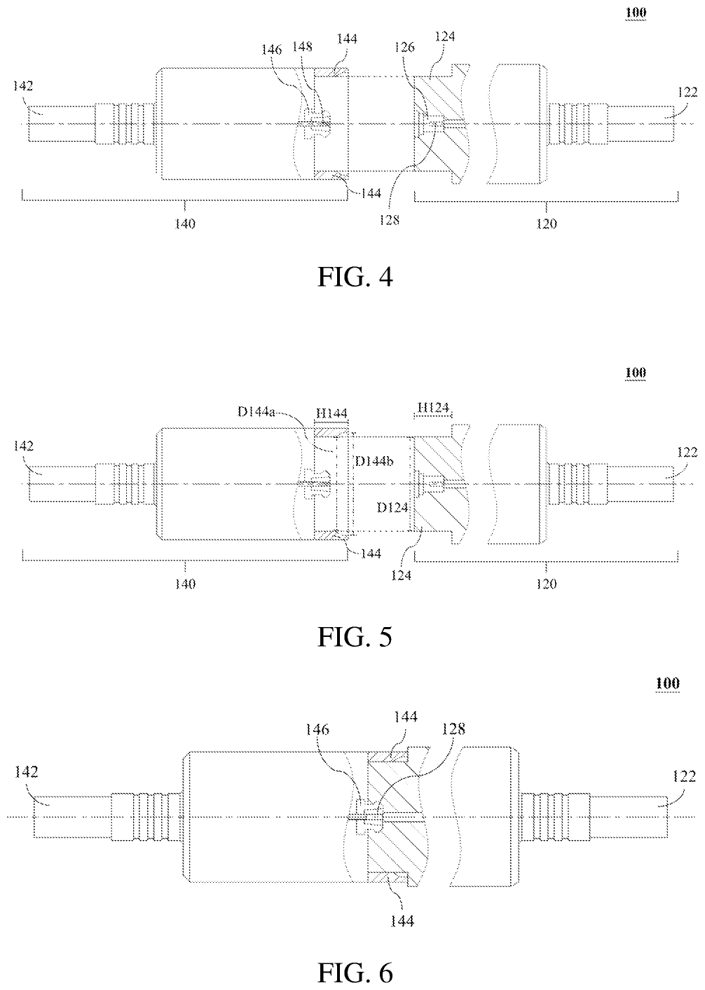

Next, please refer to FIGS. 4-6. FIG. 4 is a sectional schematic view of the male connector viewed from the A-A sectional line in FIG. 2 and the female connector viewed from the B-B sectional line in FIG. 3, and the male and female connectors are not connected. FIG. 5 is a sectional schematic view of the male connector viewed from the A-A sectional line in FIG. 2 and the female connector viewed from the B-B sectional line in FIG. 3, and the male and female connectors are not connected. FIG. 6 is a sectional schematic view of the male connector viewed from the A-A sectional line in FIG. 2 and the female connector viewed from the B-B sectional line in FIG. 3, and the male and female connectors are connected. Therefore, the sectional schematic view of the male connector 140 in FIGS. 4-6 are viewed from the A-A sectional line in FIG. 2, and the sectional schematic view of the female connector 120 in FIGS. 4-6 are viewed from the B-B sectional line in FIG. 3.

In FIGS. 4-6, a guided magnetic RF connector assembly 100 is provided according to some embodiments of this disclosure. The guided magnetic RF connector assembly 100 may be applied to guided magnetic RF connectors for guided magnetically connecting magnetic RF connectors. The guided magnetic RF connector assembly 100 comprises a female connector 120 and a male connector 140.

In FIG. 4, the female connector 120 comprises a column 124 with a column diameter D124 (shown in FIG. 5), a connection groove 126, and a socket 128. The connection groove 126 is sunken at the central axis of the column 124 and surrounds the socket 128. The socket 128 is located at the central axis of the connection groove 126.

The male connector 140 comprises a guide groove 144, a plug 146, and a plug terminal 148. The guide groove 144 has a funnel-like shape. An upper diameter D144b (shown in FIG. 5) at the open side of the guide groove 144 is greater than the column diameter D124, and a lower diameter D144a (shown in FIG. 5) near the bottom side of the guide groove 144 is adapted to the column diameter D124. The plug terminal 148 is located at the central axis of the guide groove 144 and connects to the socket 128. The plug 146 surrounds the plug terminal 148. When the plug terminal 148 is connected to the socket 146, the plug 146 is adapted to engage with the connection groove 126.

According to some other embodiments, in FIG. 5, the positions of the lower diameter D144a and the upper diameter D144b can be connected by a straight line, an arc line, or a step line.

In FIG. 5, the height H124 of the column 124 of the female connector 120 is greater than the height H144 of the guide groove 144. Hence, the female connector 120 may be easily connected to the male connector 140, and the outer surface of the column 124 can contact, adapt, or tightly fit to connect the bottom part of the guide groove 144.

According to some embodiments of this disclosure, at least one of the column 124 and the guide groove 144 is magnetic, so that the female connector 120 and the male connector 140 can be guided to engage with each other through magnetic attraction force.

According to some other embodiments of this disclosure, how to guide the connection of the female connector 120 and the male connector 140 of the guided magnetic RF connector assembly 100 are described in detail as follows.

First, in FIG. 4, the female connector 120 and the male connector 140 are magnetically attracted to each other.

Next, the column 124 of the female connector 120 is magnetically guided by the guide groove 144 of the male connector 140 to gradually approach the bottom part of the guide groove 144. Further, the upper diameter D144b of the guide groove 144 is larger than the lower diameter D144a, and the lower diameter D144a is adapted to the column diameter D124 of the column 124. Therefore, when the column 124 of the female connector 120 and the guide groove 144 of the male connector 140 approach through magnetic attraction, the column 124 will be guided by the guide groove 144 to accurately connect the bottom part of the guide groove 144 to complete the “magnetic orientation.”

Then, the connection groove 126 of the female connector 120 is close to the plug 146 of the male connector 140, and the connection groove 126 and the plug 146 can be further engaged by manual force to simultaneously connect the socket 128 of the female connector 120 and the plug terminal 148 of the male connector 140. Hence, the “connection” is completed, as shown in FIG. 6.

Optionally, according to the degree of the tightness between the connection groove 126 and the plug 146, it may be determined whether manual force or a particular strength of other force is required to engage the connection groove 126 and the plug 146. For example, when the degree of tightness between the connection groove 126 and the plug 146 is low, the magnetic guidance itself can almost connect the connection groove 126 and the plug 146. However, when the degree of tightness between the connection groove 126 and the plug 146 is high, even after the magnetic guidance, a force in the vertical direction is still needed to connect the connection groove 126 and the plug 146. Accordingly, the guided magnetic RF connector assembly 100 above can offer the convenience of “blind insertion” to operators.

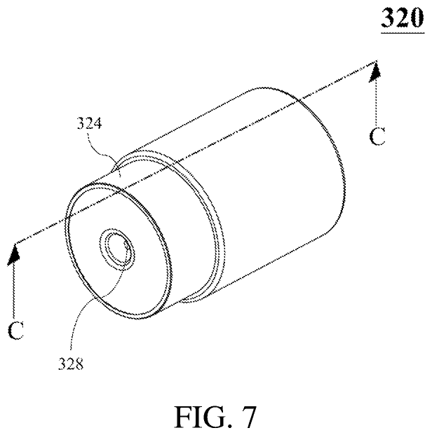

In FIGS. 7-10, a guided magnetic RF adapter assembly is provided according to some embodiments of this disclosure. The model of the male connector 140 and the RF adapter 320 may be 1.0 mm, SMPS, 1.35 mm, 1.85 mm, SMPM, 2.4 mm, 2.92 mm, SMP, 3.5 mm, SMA, and N. These models may work under various frequency bands. The maximum operating frequency band may reach 110 GHZ.

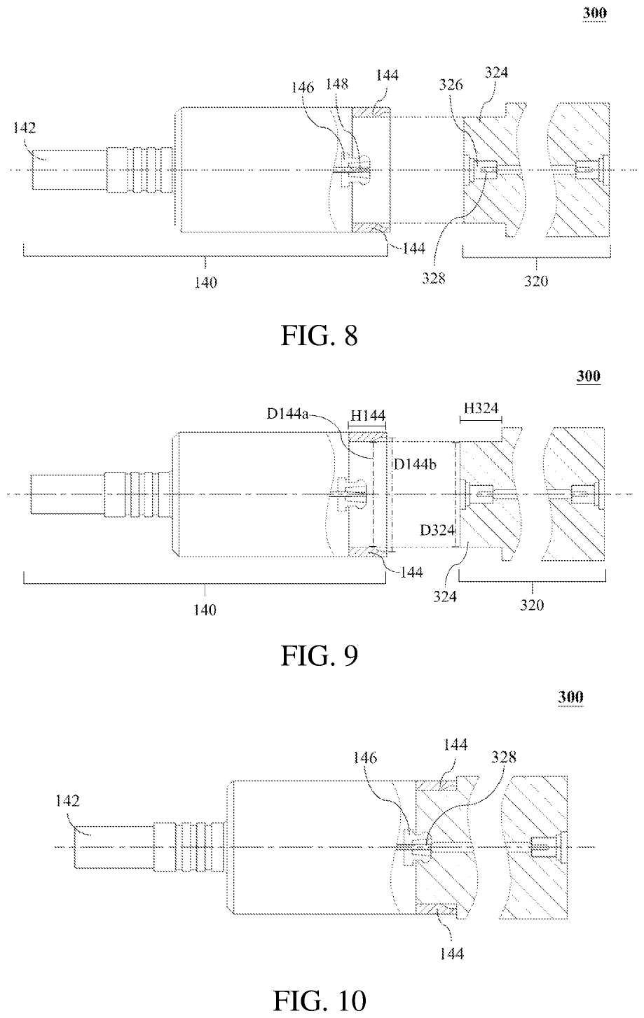

Please refer to FIGS. 7-10. FIG. 7 is a perspective schematic view of the RF adapter with a C-C sectional line, according to an embodiment of this disclosure. FIG. 8 is a sectional schematic view of the male connector viewed from the A-A sectional line in FIG. 2 and the adapter viewed from the C-C sectional line in FIG. 7, and the male connector and the adapter are not connected. FIG. 9 is a sectional schematic view of the male connector viewed from the A-A sectional line in FIG. 2 and the adapter viewed from the C-C sectional line in FIG. 7, and the male connector and the adapter are not connected. FIG. 10 is a sectional schematic view of the male connector viewed from the A-A sectional line in FIG. 2 and the adapter viewed from the C-C sectional line in FIG. 7, and the male connector and the adapter are connected. Therefore, the sectional schematic view of the male connector 140 in FIGS. 8-10 are viewed from the A-A sectional line in FIG. 2, and the sectional schematic view of the RF adapter 320 in FIGS. 8-10 are viewed from the C-C sectional line in FIG. 7.

In FIGS. 7-10, according to some embodiments of this disclosure, a guided magnetic RF adapter assembly 300 comprising a guided magnetic RF adapter is provided for magnetically connecting guided magnetic RF connectors. The guided magnetic RF adapter assembly 300 comprises an adapter 320 and a male connector 140.

In FIG. 8, the adapter 320 comprises an adapter column 324 with an adapter column diameter D324 (shown in FIG. 9), an adapter connection groove 326, and an adapter socket 328. The adapter connection groove 326 is sunken at the central axis of the adapter column 324 and surrounds the adapter socket 328. The adapter socket 328 is located at the central axis of the adapter connection groove 326.

The male connector 140 comprises a guide groove 144, a plug terminal 148, and a plug 146. The guide groove 144 has a funnel-like shape. An upper diameter D144b (shown in FIG. 9) at the open side of the guide groove 144 is greater than the adapter column diameter D324, and a lower diameter D144a (shown in FIG. 9) near the bottom side of the guide groove 144 is adapted to the adapter column diameter D324. The plug terminal 148 is located at the central axis of the guide groove 144, and the plug terminal 148 is used to connect the adapter socket 328. The plug 146 surrounds the plug terminal 148. When the plug terminal 148 is connected to the adapter socket 328, the plug 146 is adapted to engage with the adapter connection groove 326.

According to some other embodiments of this disclosure, in FIG. 9, the positions of the lower diameter D144a and the upper diameter D144b can be connected by a straight line, an arc line, or a step line.

According to yet some other embodiments of this disclosure, the opposite side of the RF adapter 320 connecting the male connector 140 may be connected to another female connector so that the adapter 320 is an adapter of “male to female.”

According to yet some other embodiments of this disclosure, the opposite side of the RF adapter 320 connecting the male connector 140 may be connected to another male connector so that the adapter 320 is an adapter of “male to male.”

In FIG. 9, according to some embodiments of this disclosure, the height H324 of the adapter column 324 of the RF adapter 320 is greater than the height H144 of the guide groove 144. Hence, the adapter 320 may be easily connected to the male connector 140, and the outer surface of the adapter column 324 can contact, adapt or tightly fit to connect the bottom part of the guide groove 144.

According to some embodiments of this disclosure, at least one of the adapter column 324 and the guide groove 144 is magnetic, so that the adapter 320 and the male connector 140 can be guided to engage with each other through magnetic attraction force.

According to some other embodiments of this disclosure, how to guide the connection of the RF adapter 320 and the male connector 140 of the guided magnetic RF adapter assembly 300 are described in detail as follows.

First, in FIG. 8, the adapter 320 and the male connector 140 are magnetically attracted to each other.

Next, the adapter column 324 of the RF adapter 320 is magnetically guided by the guide groove 144 of the male connector 140 to gradually approach the bottom part of the guide groove 144. Further, the upper diameter D144b of the guide groove 144 is larger than the lower diameter D144a, and the lower diameter D144a is adapted to the adapter column diameter D324 of the adapter column 324. Therefore, when the adapter column 324 of the RF adapter 320 and the guide groove 144 of the male connector 140 approach through magnetic attraction, the adapter column 324 will be guided by the guide groove 144 to accurately connect the bottom part of the guide groove 144 to complete the “magnetic orientation.”

Then, the adapter connection groove 326 of the RF adapter 320 is close to the plug 146 of the male connector 140, and the adapter connection groove 326 and the plug 146 can be further engaged by manual force to simultaneously connect the adapter socket 328 of the RF adapter 320 and the plug terminal 148 of the male connector 140. Hence, the “connection” is completed, as shown in FIG. 10.

Optionally, according to the degree of the tightness between the adapter connection groove 326 and the plug 146, it may be determined whether manual force or a certain strength of other force is required to engage the adapter connection groove 326 and the plug 146. For example, when the degree of tightness between the adapter connection groove 326 and the plug 146 is low, the magnetic guidance itself can almost connect the adapter connection groove 326 and the plug 146. However, when the degree of tightness between the adapter connection groove 326 and the plug 146 is high, even after the magnetic guidance, a force in the vertical direction is still needed to connect the adapter connection groove 326 and the plug 146.

Accordingly, the guided magnetic RF adapter assembly 300 above can offer the convenience of “blind insertion” to operators.

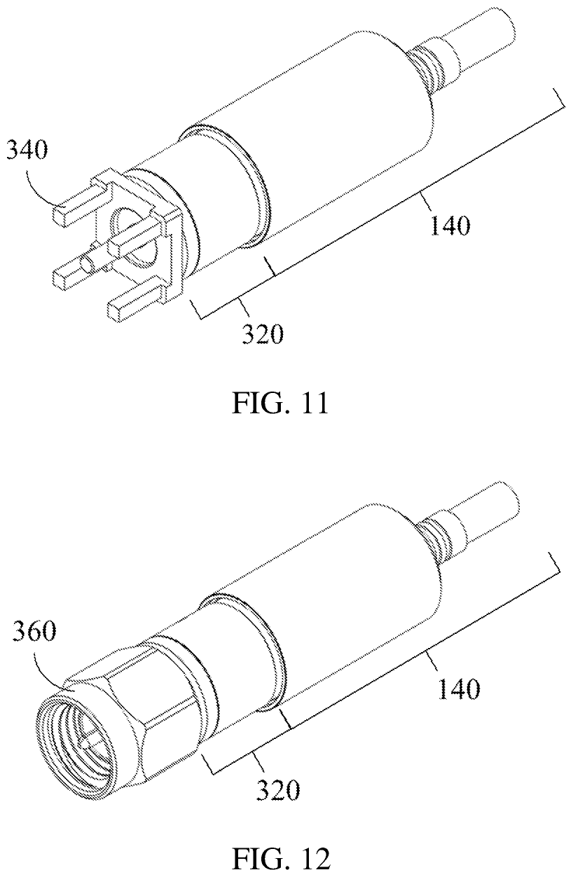

FIG. 11 is a perspective schematic view of a male connector connected to a PCB adapter, according to an embodiment of this disclosure. In FIG. 11, one end of the RF adapter 320 connects a male connector 140, and the other end of the RF adapter 320 connects a PCB (printed circuit board) adapter 340 for connecting a printed circuit board. Hence, an electrical signal may be transmitted through the RF adapter 320 and the PCB adapter 340 into or from the printed circuit board connected to the PCB adapter 340. The printed circuit board adapter 340 is connected to the PCB in a “locking” manner, and the “locking” structure is used to transmit high-frequency signals, especially those above 18 GHZ. According to the testing results of transmitting high-frequency signals, when a PCB adapter is connected to a PCB by “soldering”, noise is easily generated due to the possibility of voids in the soldering. The PCB adapter 340 is connected to a PCB through the screws of the PCB in the “locking” manner. Hence, the PCB adapter 340 may be connected to the PCB at any positions having screws.

FIG. 12 is a perspective schematic view of a male connector connected to a threaded adapter, according to an embodiment of this disclosure. In FIG. 12, one end of the RF adapter 320 connects a male connector 140, and the other end of the RF adapter 320 connects a to threaded adapter 360 for connecting a printed circuit board or a RF connector.

Accordingly, in the guided magnetic RF connector assembly and the guided magnetic RF adapter assembly, the guide groove of the male connector allows the female connector or the RF adapter can easily connect to the male connector. Hence, the problem of the high probability of damage during the connection of conventional magnetic RF connectors can be easily solved.

It should be understood that the examples and the embodiments described herein are for illustrative purposes only, and various modifications or changes in view of them will be suggested to those skilled in the art and will be included in the scope of the application and thus the scope of the appended claims.

What is claimed is:

1. A guided magnetic RF connector assembly, adapted to magnetically connect guided magnetic RF connectors, the assembly comprising:
a female connector, comprising:
a column having a column diameter;
a connection groove sunken at a central axis of the column; and
a socket located at a central axis of the connection groove and thus surrounded by the connection groove; and
a male connector, comprising:
a guide groove having a funnel-like shape, wherein an upper diameter at an open side of the guide groove is greater than the column diameter, and a lower diameter near a bottom side of the guide groove is adapted to the column diameter;
a plug terminal located at a central axis of the guide groove for connecting the socket; and
a plug surrounding the plug terminal, wherein the plug is adapted to engage with the connection groove when the plug terminal is connected to the socket.

2. The assembly of claim 1, wherein a height of the column of the female connector is greater than a height of the guide groove.

3. The assembly of claim 1, wherein at least one of the column and the guide groove is magnetic.

4. A method for connecting the assembly of claim 1, and the method comprising:
magnetically attracting the female connector and the male connector;
magnetically guiding the column of the female connector close to the guide groove of the male connector; and
connecting the connection groove of the female connector and the plug of the male connector to simultaneously connect the socket of the female connector and the plug terminal of the male connector.

5. The method of claim 4, wherein a height of the column of the female connector is greater than a height of the guide groove.

6. The method of claim 4, wherein at least one of the column and the guide groove is magnetic.

7. A guided magnetic RF adapter assembly, comprising:
a RF adapter for magnetically connecting magnetic RF connectors, the RF adapter comprising:
an adapter column having an adapter column diameter;
an adapter connection groove sunken at a central axis of the adapter column; and
an adapter socket located at a central axis of the adapter connection groove and thus surrounded by the adapter connection groove;
a male connector, comprising:
a guide groove having a funnel-like shape, wherein an upper diameter at an open side of the guide groove is greater than the adapter column diameter, and a lower diameter near a bottom side of the guide groove is adapted to the adapter column diameter;
a plug terminal located at a central axis of the guide groove for connecting the socket; and
a plug surrounding the plug terminal, wherein the plug is adapted to engage with the connection groove when the plug terminal is connected to the adapter socket.

8. The assembly of claim 7, wherein an opposite side of the RF adapter connected to the male connector is connected to another female connector.

9. The assembly of claim 7, wherein an opposite side of the RF adapter connected to the male connector is connected to another male connector.

10. The assembly of claim 7, wherein a height of the adapter column of the RF adapter is greater than a height of the guide groove.

11. The assembly of claim 7, wherein at least one of the adapter column and the guide groove is magnetic.

12. A method for connecting the assembly of claim 7, the method comprising:
magnetically attracting the RF adapter and the male connector;
magnetically guiding the adapter column of the RF adapter close to the bottom part of the guide groove of the male connector; and
connecting the adapter connection groove of the RF adapter and the plug of the male connector to simultaneously connect the adapter socket of the RF adapter and the plug terminal of the male connector.

13. The method of claim 12, wherein an opposite side of the RF adapter connected to the male connector is connected to another female connector.

14. The method of claim 12, wherein an opposite side of the RF adapter connected to the male connector is connected to another male connector.

15. The method of claim 12, wherein a height of the adapter column of the RF adapter is greater than a height of the guide groove.

16. The method of claim 12, wherein at least one of the adapter column and the guide groove is magnetic.
